(19) United States
(12) Patent Application Publication
(10) Pub. No.: US 2023/0119635 A1
(43) Pub. Date: Apr. 20, 2023

(54) UNIVERSAL SEALED HEAT EXCHANGER AIR CONDITIONER

(71) Applicants: Zachary Benson, Siren, WI (US); Moto Alliance, Inc., Rogers, MN (US)

(72) Inventor: Zachary Benson, Siren, WI (US)

(21) Appl. No.: 17/965,897

(22) Filed: Oct. 14, 2022

Related U.S. Application Data
(60) Provisional application No. 63/255,778, filed on Oct. 14, 2021.

(51) Int. Cl. B60H 1/00

(52) U.S. Cl. CPC B60H 1/00028; B60H 2001/00078

(57) ABSTRACT

An economical air conditioner system for universal installation in utility vehicles (UTV) and other 12v applications is a fluid cooling system that may also be used for heating applications. The system is a sealed system wherein cooling fluids can include ice water, and the sealed system allows for improved ice retention. The sealed system may alternatively utilize a traditional coolant in the cooling system which provides for the ability to switch between “heat” and “cool” applications or functions using the same core in the system. The system includes a storage vessel, a pump, a fluid reservoir, and a heat exchanger installed within the storage vessel. The system is also operably connectable to a core for temperature selected and directed air flow.

### CROSS-REFERENCE TO RELATED APPLICATIONS

This application claims priority to and the benefit of U.S. provisional patent application Serial No. 63/255,778, filed on Oct. 14, 2021, the contents of which are herein incorporated in their entirety.

### BACKGROUND

The present invention relates to a universal heat exchanger air conditioner and more specifically relates to a universal sealed heat exchanger air condition for UTV and other 12v applications.

Utility Terrain Vehicles (UTVs) and All Terrain Vehicles (ATVs) are large vehicles able to seat passengers including in a side by side manner and having an open or semi-enclosed cab. Most frequently such vehicles are not provided with a manufacturer installed air conditioner. The open or semi-open nature of the cab, reinforcing structure of the cab, and use of the vehicles in tough terrain generally makes heating and cooling of the seating area of these vehicles inefficient if done at all. Moreover, the additional equipment for a factory installed AC unit may be cost prohibitive and provide added undesirable weight to the vehicle.

### SUMMARY

An aspect of the present disclosure relates to a sealed universal controlled temperature air flow system comprising a storage vessel, a pump for circulating fluid, a fluid reservoir, and a heat exchanger positioned within an interior space of the storage vessel.

In one or more embodiments, the storage vessel is a cooler.

In one or more embodiments, ice, water, or a combination thereof are loaded into the interior space of the storage vessel outside to surround the heat exchanger positioned therewithin.

The heat exchanger is a coil constructed of a thermally conductive material and is positioned within the interior space of the storage vessel and the coil directs a fluid flow into, through, and out of the storage vessel.

The system can be installed in an environment having a power source and the power source may be a battery. The system can be installed in any vehicle, UTV, or towable enclosure having a power source, for example.

The system is operably connected to a core for providing temperature adjusted air flow to a vehicle, UTV, or enclosure where the system is connected to a power source and operably installed.

The system is configured to switch between heat and cool functions such that the system is a universal installation capable of both heating and air conditioning. The system further comprises a coolant “Y” diverter with a shut off valve installed on inlet and return lines connecting the system to an engine of a vehicle or UTV in which the system is installed for selectively switching between heating and cooling functions.

In one or more embodiments, the storage vessel has dimensions sufficient to allow the storage vessel to be operably mounted on a storage rack or storage space on or in a vehicle or UTV.

The fluid reservoir is installed inline before an inlet to the pump and between the pump and the storage vessel and wherein the fluid reservoir allows for the purging of air from the sealed system and assists in cooling the fluid used in the sealed system.

In one or more embodiments, the core and pump are connected to the same power source such that the pump and core are actuated together.

### BRIEF DESCRIPTION OF THE DRAWINGS

FIG. 1 a perspective view of a cooler base with a heat exchanging coil therein.

FIG. 2 is a front, cross-sectional view of the cooler base with the heat exchanger therein and according to embodiments described herein.

### DETAILED DESCRIPTION

An economical air conditioner system that can be universally installed in utility vehicles (UTV) and other 12v applications is described herein. The system is a fluid cooling system that may also be used for heating applications. The system is a sealed system wherein cooling fluids can include ice water, and the sealed system allows for improved ice retention. The sealed system may alternatively utilize a traditional coolant in the cooling system which provides for the ability to switch between “heat” and “cool” applications or functions using the same core in the system.

The system comprises a storage vessel, a pump, a fluid reservoir, and a heat exchanger installed within the storage vessel. In one or more embodiments where the system allows for both heating and cooling functions, the system may also comprise a diverter as discussed in further detail below. In one or more embodiments as described in further detail below, the system is then operably connectable to a core for temperature selected and directed air flow.

The storage vessel may be a cooler, ice chest or other container for storage and retention of ice and/or ice and water. At a minimum the heat exchanger within the storage vessel needs to be packed in ice and the storage vessel filled with sufficient ice to do so. Water is then added to the storage vessel to ensure thermal contact between heat exchanger coil and the ice. Additional ice beyond this minimum would not dictate cooling capacity, but would effect cooling duration. The cooling temperature can instead be adjusted via flow control (air control) on the heater core, where for example, restricting the air flow would increase the air temperature of the air flow out of the core.

A capacity of the storage vessel may vary based on application or end use installation of the system, and the amount of ice stored and/or utilized in the storage vessel can be adjusted based on the capacity of the storage vessel, a selected cooling run time, end use installation, or combinations thereof.

The pump may be an inline pump and the pump is configured to circulate fluids through a heat exchanger coil positioned inside the storage vessel and a cooling core installed in the unit. The unit may be a UTV, vehicle, or other enclosure having a power source. In one embodiment, the pump is a 12v inline pump. The inline pump pumps the coolant through the sealed system. The coolant is pumped through a heat exchanger or heat exchanger coil that is packed in the ice and water inside the storage vessel or “cooler.” The fluid then circulates through a core installed inside the unit. Air may then be blown across the cold core thus conditioning the air and creating a cooling effect.

The heat exchanger may be a coil comprised of a thermally conductive material. The coil may be, for example a metal coil. The coil may be comprised any thermally conductive material, such as copper or like materials.

In an embodiment where the system comprises the ice and water for cooling the heat exchanger coil, the system may be, referred to also as an “ice cooler heat exchanger,” the inline pump and reservoir are installed on the outside of the storage vessel and the coil for heat exchanging is installed inside the storage vessel.

Flow of coolant or fluid by the pump will directly influence maximum temperature reduction of the air conditioner system. For example, a higher rate of flow creates a greater cooling capacity which is limited by the surface area/BTU rating of the core used, as well as the surface area of the heat exchanger coil inside the storage vessel. The use of an inline pump in a sealed system as described herein allows for the use of different fluids for cooling as an alternative to the water as a cooling medium.

The fluid reservoir is an inline fluid reservoir which allows for purging of air from the sealed system and assists in cooling the fluid used in the sealed system.

As mentioned above, the heat exchanger is a heat exchanging coil that may be installed inside the storage vessel and configured to cool the coolant or liquid being pumped through the system. A cavity in the storage vessel surrounding the coil length therein may be filled with water and ice to cool the liquid pumped therethrough. As the system is sealed, the system may operate optimally with cool water as well as fluids other than water for coolant. However, in embodiments wherein a traditional coolant is used, the system functions as both a heating and cooling unit and is configured to allow an end user to selectively switch between heating and cooling functions without changing the core as this can be done with the same core.

In one or more embodiments where the system is capable of both heating and cooling functions and switching therebetween, a coolant “Y” or diverter may be provided and installed in the system to control switching. The diverter may be a traditional coolant “Y” with a shut off valve that may be installed on an inlet and return heater lines coming from an engine on a traditional heater kit install. A shut off will allow the vehicle's cooling system to remain sealed and thus prevent “back flow” into the cooling lines. The cooling lines may also be capped when not in use.

The system, which may be referred to as a heater and/or cooling system is connectable to a core any may be installed in a UTV and act as an air “heat exchanger” for conditioning air and creating a cooling effect when air is blown across the cold core which is cooled by the coolant or cold liquid circulated through the core.

The core may be a universal core for universal installation, but it is also within the scope of this disclosure that the core is a vehicle specific core. In the embodiment wherein the core is a vehicle specific core, the core from nearly any pre-existing or third-party heater manufacture can be utilized with this system.

In an embodiment wherein the core is a universal core, the universal core may be installed or utilized in applications dictated by the end user including but not limited to installation in an UTV, automobile, camping structure, accessory or device, and anywhere a 12v power source is available for connection to the system.

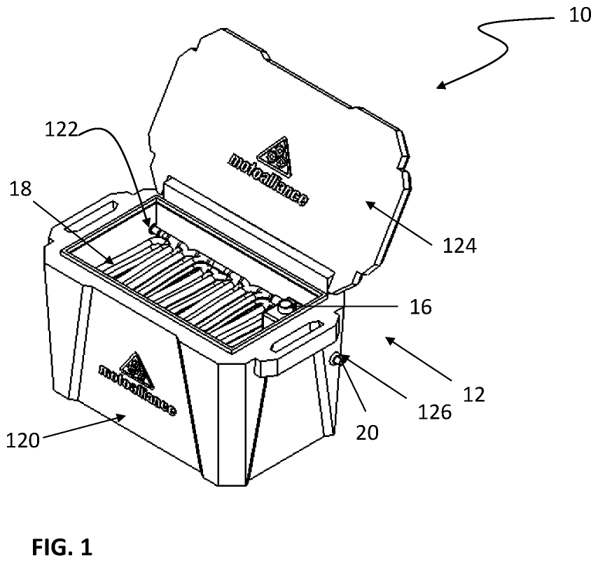

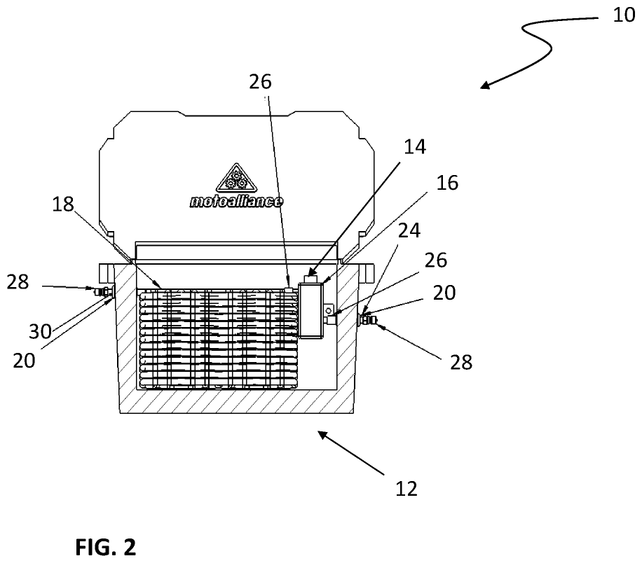

In further detail, in one embodiment as illustrated in FIGS. 1-2, the system 10 comprises a storage vessel 12, a pump 14, a fluid reservoir 16, and a heat exchanger 18 operably installed within the storage vessel 10.

The storage vessel 12 is a walled housing 120 with a cavity 122 therein and having a lid 124. The lid 124 allows for easy access to the cavity 122 and can be secured with a friction fit the housing 120 and/or by way of an addition lock mechanism. The cavity is configured to operably support the operating components therein such as the pump 14, fluid reservoir 16, and heat exchanger 18. The storage vessel 12 may also be insulated. For example, the storage vessel 12 may be a pre-existing “cooler” where the components are installed in the cooler and the cooler has handles and a lightweight but sturdy constructed that allows the system to be portable, stored on the UTV and/or easily connected and disconnected for use.

The storage vessel 12 may then be modified with openings 126 in one or more side walls of the housing 120. The vessel 12 then support grommets 20 which are installed and pass through the openings 126 in opposing side walls of the storage vessel 12. The grommets 20 allow for controlled transfer of fluid through the storage vessel 12 wall. An inlet side 22 of the heat exchanger 18 may be threaded and inserted through a rubber grommet 20, such as a 5″ rubber grommet. A ⅝ barbed fitting×⅜ NPT female pipe thread is installed on a threaded ⅜ NPT pipe 24 and is connected to a 5/8″ radiator hose 26. A 5/8″ barbed fitting× 11/16″ NPT female thread is installed on the inlet and outlet of the in-line pump 14. This allows for a ⅝″ radiator hose 26 to be connected to the inlet and outlet of the pump 14. The threaded end of the inlet is inserted through the rubber grommet. A ⅜ NPTF Female international standard ISO B hose coupling 28 is inserted on the inlet of the heat exchanger and the threaded ⅜″ NPT pipe 30 is inserted in the grommet 20 at the outlet of the storage vessel 12. The ⅜ NPTF Female international standard ISO B hose coupling 28 allows for quick and safe disconnection for storage of the vessel when not in use.

One embodiment of the heat exchanger 18 comprises a 120′ 5/8 REF soft copper coil and rubber grommets which attach and seal fittings for the storage vessel 12 and fluid reservoir 16.

The pump 14 may be a 12v In-line Pump with ½ NPT inlet and outlet to allow for the circulation of the fluids and a relay and 12v supply connector may be run from the core so the pump 14 only operates when the blower/core is in operation.

The fluid reservoir 16 may be secured to the inside of the storage vessel 12 using ¼″ self-tapping screws. The reservoir 16 has two ⅝″ tubed exits. The inlet is attached to a 5/8″ radiator hose 26A that is connected to the heat exchanger 18. The outlet is attached to ⅝″ radiator hose 26B that is connected to a threaded ⅜ NPT pipe.

The system 10 according to one or more embodiments herein may be installed in any vehicle where a power source, such as a 12v power source, is available. The power source may be a 12v battery and alternator set up, or a standalone 12v battery with an external charger utilized to recharge the battery. The system 10 may also be installed in a vehicle having a space for ice cooler/storage, for example a traditional UTV cargo box. The storage vessel 12 can also be mounted on a rack or in the cab of the UTV for example. The size and design of the storage vessel 12 may also be configured to meet a specific end use, installation location, or otherwise tailored to the end user's specific needs.

The system 10 may also require clearance for routing of water lines from the storage vessel or cooler to the core. The dimensions and shape of the design can be optimized with vehicle specific applications, however there is no limiting factor in how water lines may be routed.

Cooling losses may also be minimized by keeping water lines as short as possible and insulating one or more components including the water lines from external heat sources.

The core may be installed according to vehicle specific installation instructions provided by the manufacture of the core. However, where a universal core is utilized, the core can be mounted in any manner selected by the end user. For example, installation comprises installing the removable storage vessel in a selected location and running the coolant or water lines from the storage vessel to the core. The size of the coolant lines will be dictated by the core utilized. Additionally, if both heating and cooling are desired, the diverter (“Y”) with shut-offs will be installed on the supply and return line from the engine to the core. The lines may then be connected and installed using a proper barb and swivel garden hose adapter or similar adapter and the system connected to the power source.

Although the present disclosure has been described with reference to preferred embodiments, workers skilled in the art will recognize that changes may be made in form and detail without departing from the spirit and scope of the disclosure.

1. A sealed universal controlled temperature air flow system comprising:
a storage vessel having an interior space;
a pump for circulating fluid;
a fluid reservoir; and
a heat exchanger;
wherein the pump, fluid reservoir and heat exchanger are operably secured within the interior space of the storage vessel, and
wherein the system is operably connected to a core for providing temperature adjusted air flow to a vehicle, UTV, or enclosure where the system is connectable to a power source and operably installed.

2. The system of claim 1 wherein the storage vessel is a cooler.

3. The system of claim 1 wherein ice, water, or a combination thereof are loaded into the interior space of the storage vessel to surround the heat exchanger positioned therewithin.

4. The system of claim 1 wherein the heat exchanger is a coil comprised of a thermally conductive material and is positioned within the interior space of the storage vessel and wherein the coil directs a fluid into, through, and out of the storage vessel.

5. The system of claim 1 and further comprising a power source wherein the power source is a battery.

6. The system of claim 1 wherein the system can be installed in any vehicle, UTV, or towable enclosure having a power source.

7. The system of claim 1 wherein the system is configured to switch between heat and cool functions such that the system is a universal installation capable of both heating and air conditioning.

8. The system of claim 7 wherein the system further comprises a coolant “Y” diverter with a shut off valve installed on inlet and return lines connecting the system to an engine of a vehicle or UTV in which the system is installed.

9. The system of claim 1 wherein the storage vessel has dimensions sufficient to allow the storage vessel to be operably mounted on a storage rack or storage space on or in a vehicle or UTV.

10. The system of claim 1 wherein the fluid reservoir is installed inline before an inlet to the pump and between the pump and the heat exchanger and wherein the fluid reservoir allows for the purging of air from the sealed system and assists in cooling the fluid used in the sealed system.

11. The system of claim 1 wherein the core and pump are connected to the same power source such that the pump and core are actuated together.
